(19) United States
(12) Patent Application Publication
(10) Pub. No.: US 2022/0292489 A1
(43) Pub. Date: Sep. 15, 2022

(54) METHODS AND DEVICES FOR TRACKING AND MEASURING PROOF-OF-WORK CONTRIBUTIONS IN A MINING POOL

(71) Applicant: nChain Licensing AG, Zug 6300 (CH)

(72) Inventors: Alexander MACKAY, London (GB); Owen VAUGHAN, London (GB)

(21) Appl. No.: 17/639,858

(22) PCT Filed: Sep. 2, 2020
(86) PCT No.: PCT/IB2020/058175

§ 371 Date: Mar. 2, 2022

(30) Foreign Application Priority Data
Sep. 6, 2019 (GB) 1912862.8

(51) Int. Cl. G06Q 20/36; H04L 9/00; H04L 9/32; G06Q 20/40

(52) U.S. Cl. CPC G06Q 20/3672; H04L 9/50; H04L 9/3218; G06Q 20/401; G06Q 2220/00

(57) ABSTRACT

Methods and devices to track proof-of-work contributions from mining devices in a mining pool. The mining pool includes a pool master computing device that stores a bloom filter. The bloom filter stores candidate block header information that meets a partial proof-of-work standard based on regular reports from the mining devices during their proof-of-work searching. On receipt of new candidate block header information form one of the mining device, the pool master constructs a candidate block header using the information and assesses whether it is already stored in the bloom filter. If not, then it stores the block header in the bloom filter. If so, then it records a bad hash in association with the mining device that reported it.

### CROSS REFERENCE TO RELATED APPLICATIONS

This application is a U.S. National Stage of PCT Application No. PCT/IB2020/058175 filed on Sep. 2, 2020, which claims the benefit of United Kingdom Application No. 1912862.8, filed on Sep. 6, 2019, the entire contents of which are incorporated herein by reference.

### TECHNICAL FIELD

The present disclosure relates to blockchain networks and, in particular, to mining pools.

### BACKGROUND

Mining nodes (or “miners”) are key elements of a blockchain network. In “proof-of-work” blockchain networks, the mining nodes compete to complete a proof-of-work in order to “win” the race to mine a block and thereby collect the transaction fees and any newly-minted tokens reflected in a coinbase transaction within the new block. In this manner, the miners secure the network, ensuring that transactions are valid and that all participating nodes conform to the prevailing blockchain protocol.

As the network scales and proof-of-work searches become more computationally difficult, mining pools will be more common, at times involving tens or thousands or hundreds of thousands of mining devices. Accurately and reliably tracking the activity of those mining devices in order to measure their relative contributions is a significant challenge. Any system of measuring hashpower contributed to solving the proof-of-work needs to address the possibility of a malicious device attempting to claim more hashpower than it actually contributes and faulty devices that operate during the search but fail to make substantive contributions.

### BRIEF DESCRIPTION OF THE DRAWINGS

Reference will now be made, by way of example, to the accompanying drawings which show example embodiments of the present application and in which:

FIG. 1 illustrates an example bloom filter;

FIG. 2 illustrates the example bloom filter and the process of determining whether data is already stored in the bloom filter;

FIG. 3 shows, in flowchart form, one example method of tracking proof-of-work contributions from mining devices;

FIG. 4 shows, in flowchart from, another example method of tracking proof-of-work contributions from mining devices; and

FIG. 5 shows, in block diagram form, a simplified example of a computing node, such as a mining node.

Like reference numerals are used in the drawings to denote like elements and features.

### DETAILED DESCRIPTION OF EXAMPLES

In one aspect, there may be provided a computer-implemented method of tracking proof-of-work contributions from mining devices within a mining pool, the mining pool having a pool master computing device that stores a bloom filter. The method may include receiving candidate block header information from a first mining device within the pool; constructing a candidate block header based on the candidate block header information; determining that the candidate block header is not stored in the bloom filter; and, based on the determination that the bloom filter does not contain the candidate block header, updating the bloom filter to store the candidate block header in the bloom filter.

In some implementations, the candidate block header information may include a nonce value and constructing may include inserting the nonce value in the candidate block header. In some cases, the candidate block header information may include coinbase transaction data, and constructing the candidate block header may include building a merkle tree based, in part, on the coinbase transaction data and populating a merkle root field of the candidate block header based on the merkle tree.

In some implementations, the bloom filter may include a bit array, and determining that the candidate block header is not stored in the bloom filter may include hashing the candidate block header using k hash functions to identify k bit positions, and determining that at least one of the k bit positions in the bit array is set to zero. In some cases, hashing using k hash functions may include repeatedly hashing the candidate block header k times using one hash function. In some cases, updating the bloom filter may include setting bits of the bit array in the k bit positions to 1.

In some implementations, the method may include receiving second candidate block header information from a second mining device within the pool; constructing a second candidate block header based on the second candidate block header information; determining that the second candidate block header is likely stored in the bloom filter; and, based on the determination that the bloom filter likely contains the second candidate block header, incrementing a count of invalid candidate blocks associated with the second mining device. In some cases, the bloom filter may include a bit array, and determining that the second candidate block header is likely stored in the bloom filter may include hashing the second candidate block header using k hash functions to identify k bit positions, and determining that all of the k bit positions in the bit array are set to one.

In some implementations, the method may include hashing the candidate block header to produce a hash result, comparing the hash result to a higher threshold value set by a second difficultly parameter, and determining that the hash result is less than the higher threshold value. The method may also include determining that a time of receipt between two or more partial proof-of-work reports containing candidate block header information from the first mining device deviates from a target duration by more than a threshold amount and, on that basis, adjusting the second difficulty parameter and sending the adjusted second difficultly parameter to the first mining device.

In some implementations, the method may include determining that a valid block has been found by the mining pool and determining a share of a block reward allocated to the first mining device based on one or more of: a second difficulty parameter associated with the first mining device, a history of second difficulty parameters associated with the first mining device while mining the valid block, or a count of partial proof-of-work reports received from the first mining device while mining the valid block.

In some implementations, the method may include determining a count of bad hashes associated with each mining device in the mining pool and adjusting a relative share of block rewards allocated to each mining device based on the count of bad hashes associated with each respective mining device. In some cases, the count of bad hashes for a particular mining device is incremented by one when the particular mining device sends candidate block header information that either does not result in a hash value below a higher threshold value or is determined to already be stored in the bloom filter.

In another aspect, there may be provided a computing device implementing a node in a network. The computing device may include memory, one or more processors, and computer-executable instructions that, when executed, cause the processors to carry out one or more of the methods described herein. The memory may store the bloom filter.

In yet another aspect, there may be provided a computer-readable medium storing processor-executable instructions for operating a node in a network, the processor-executable instructions including instructions that, when executed by one or more processors, cause the processors to carry out at least one of the methods described herein.

Other example embodiments of the present disclosure will be apparent to those of ordinary skill in the art from a review of the following detailed description in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

The present application will refer to hashing or a hash function, which is intended to include any one of a number of cryptographic hash functions that, when applied to an arbitrary set of data or “message”, deterministically produce a unique fixed-length alphanumeric string. The result of a hash function may be called a hash value, fingerprint, hash result, or equivalent. Examples include, but are not limited to, SHA-2, SHA-3, and BLAKE2.

In this document the term ‘blockchain’ is understood to include all forms of electronic, computer-based, distributed ledgers. These include consensus-based blockchain and transaction-chain technologies, permissioned and un-permissioned ledgers, shared ledgers and variations thereof. While example blockchain protocols may be discussed below for illustrative purposes, the present application is not limited to use with any particular blockchain or blockchain protocol, and alternative blockchain implementations and protocols fall within the scope of the present application.

A blockchain is a peer-to-peer, electronic ledger which is implemented using a computer-based decentralised, distributed system. The blockchain is made up of blocks which in turn are made up of transactions. Each transaction is a data structure that encodes, among other possible information, the transfer of control of a digital asset between participants in the blockchain system and includes at least one input and at least one output. Each block header contains a summary of the block's contents, such as in the form of a Merkle root, and each block header contains a hash of the previous block header so that blocks become chained together to create a permanent, unalterable record of all transactions which have been written to the blockchain since its inception. Transactions contain small programs known as scripts embedded into their inputs and outputs, which specify how and under what conditions the outputs of the transactions can be accessed. On some platforms, these scripts are written using a stack-based scripting language.

The blockchain is implemented over a network of nodes. Each node is a computing device with network connectivity and executing software that carries out the applicable blockchain protocol. Nodes validate transactions and propagate them to other nodes in the network. Specialized network nodes, termed “mining nodes” or “miners”, collect a set of unconfirmed transactions, i.e. pending transactions, into a block and attempt to “mine” the block. Mining, in these examples, refers to solving a proof-of-work (POW) before any other miner in the network succeeds in solving a proof-of-work for their respective block. In some examples, a POW involves hashing a block header containing a nonce until the result of the hashing is below a threshold value that is set by a difficulty parameter. The nonce is repeatedly incremented and the hashing repeated until the result is below the threshold value or until the miner receives notice that another miner has succeeded. Variations in mining process will be familiar to those ordinarily skilled in the art.

As noted above, mining nodes are key to securing the blockchain network. Mining nodes are compensated for their work when they win the race to find a valid new block. The compensation comes through transaction fees from individual transactions and from a “coinbase” transaction that is included in the new block. A coinbase transaction has no inputs (or, more properly, an empty or null input field) and it outputs a prescribed quantity of tokens (e.g. coins) to the miner, effectively creating new tokens. A coinbase transaction may also be referred to as a “generation transaction”, and those terms may be used interchangeably herein. The coinbase or generation transaction has certain characteristics that distinguish it from regular transactions. For example, each valid block contains only one generation transaction. Each generation transaction takes no input (or the input field, if any, does not affect the transaction and is not used) and generates an output of tokens of a quantity set by the then-prevailing block reward due to a successful miner according to the governing blockchain protocol. The generation transaction is a “proof-of-work transaction”, as it can only be created by a mining node that successfully mines a block, i.e. completes a proof of work.

As blockchain networks scale, in some cases the search space for the nonce may be insufficient to solve the POW. In some example blockchains, an “extranonce” has been employed to increase the available range of changes that can be made in mining to search for a successful POW. In the case of those examples, the “extranonce” is a value put into the input of a coinbase transaction. Because the input is not used, it is available to alter data within the body of the block that will result in a change in the Merkle tree (summary of block transactions), but will not impact the transactions themselves. Changes to the Merkle tree result in a change to the Merkle tree root that is contained in the block header.

In at least one example blockchain, the hashing of the block header to find a POW is a double-hash using SHA-256. Other blockchain networks may use other hashes.

In many blockchain systems, a single entity may own, control or direct a large number of individual computers acting as mining nodes. In some cases, the resources of a plurality of mining nodes may be pooled together in a mining pool that leverages the computational power of a vast number of individual processors. As some blockchains continue to scale to accommodate larger numbers of transactions and larger transaction data, and as the difficulty increases, it will continue to be more difficult to find a successful block, requiring more mining resources (e.g. hashpower) to “win” the POW race. Accordingly, mining pools may become increasingly common.

In mining pools, a large number of mining devices, some of which are owned or operated by different entities, jointly search for a POW. If the pool is successful, then the resulting “block reward”, i.e. the transaction fees and the coinbase transaction tokens, are divided among the participants in the pool. For this purpose and others, the mining pool may include a pool master device. The pool master device may instruct the mining devices in the pool as to portions of the possible search space that they are to attempt to mine (e.g. a range of values of the nonce and/or extranonce). The pool master device may also determine the allocation of block reward due to each of the mining devices in the pool. Any references herein to a miner or a mining node or a mining device will be understood to mean a computing device configured to carry out the applicable blockchain mining protocol.

The basis for allocating block rewards is typically the proportional contribution that a mining device makes to the accumulated hashpower of the mining pool. That is, the relative contribution of computing resources used in the POW search may determine a mining device's share of any block reward. The pool master device may be tasked with determining the relative contributions to hashpower. It may be difficult for a pool master device to accurately determine proof-of-work contributions without relying on self-reporting from the mining devices, which may make the pool vulnerable to malicious claims of contributed hashpower. Moreover, the contribution, in absolute or relative terms, may vary over the block search time as resources are added or removed by a miner.

To have every mining device report every tested nonce to the pool master device would be overwhelming in terms of bandwidth and computing resources consumed. Accordingly, to track contributions of proof-of-work by pool members, the pool master device may mandate that the devices regularly prove their contribution through sending a report each time that the mining device produces a hashed block header that meets an easier, higher threshold value that is set by a second difficulty parameter. In some cases, this report may be referred to as a “partial POW”. The normal POW difficulty parameter in some example blockchains is selected to ensure that the blockchain network as a whole is likely to find a POW that is below the corresponding threshold value approximately every ten minutes on average. The second difficulty parameter may be selected such that a mining device will successfully find a hashed block header that is below the corresponding higher threshold value in a far shorter period of time. For example, the second difficulty parameter may be selected such that it will be met by the mining device every 3, 5, 7, 10, 15, or 20 seconds, as examples. That is, the second difficulty parameter is selected so as to result in a partial POW reports with a target duration between reports.

Every time that a mining device involved in the search for a successful POW hashes the block header and finds it falls below the higher threshold value, it sends a partial POW report to the pool master device. The report may include, for example, the nonce used. The pool master device has all other information relating to the block and its header. In some cases, where a mining device is permitted to alter the coinbase transaction, such as to use an extranonce, then the report may include additional information such as the extranonce or other fields altered by the mining device.

The pool master device may occasionally adjust the second difficulty parameter for each individual mining device if the reports from that mining device deviate from the target duration between reports by more than a threshold amount. The adjustment aims ensure that each mining device provides partial POW reports on average every 3, 5, 7, 10, 15, or 20 seconds, for example. The pool master device, having received a partial POW report, may then assemble the corresponding block from the information in the report and validate that it meets the higher threshold value when the block header is hashed. By adjusting the second difficulty parameter to ensure that a specific mining device is providing a report that, on average, occurs every X seconds, the pool master device effectively determines the hashpower being contributed by that specific mining device. A mining device that cannot successfully produce such a report every X seconds may have its second difficultly parameter adjusted to ensure that the corresponding higher threshold value for that mining device is more easily met. That second difficulty parameter is a measure of the contributed hashpower of the mining device.

A malicious or faulty mining device may send the same successful partial POW report multiple times, so the pool master device tracks all reports from all miners to ensure that there are no repeated reports, i.e. no “bad hashes”. A bad hash is one that has already been reported by the same mining device or that has been reported by another mining device in the same pool, since the mining devices are typically supposed to be testing separate and distinct parts of the search space. Accordingly, the pool master device may store every report sent by every mining device in the pool and, with each new report received, may test to ensure that it has not been received before.

With tens of thousands of mining devices, the pool master device may store and test the reports from all mining devices; however, as the network scales and mining pools grow to involve hundreds of thousands, or even millions, of mining devices, it may be impractical or inefficient for a pool master device to track all the reports and to quickly identify that each newly-received report is unique.

In order to improve speed and memory usage at the pool master device, in some aspects of the present application the pool master device may employ a bloom filter to store data regarding partial POW reports submitted by the mining devices in the pool. The bloom filter also provides a relatively fast mechanism for determining whether a newly-submitted report has been previously received; that is, whether the candidate block corresponding to the newly-submitted report is already stored in the bloom filter. Bloom filters are capable of showing that a piece of information has not previously been received; however, they have a chance of showing false positives. That is, there is chance that a submitted report will incorrectly appear to have been previously received. Provided the size of the bloom filter is sufficiently large, the probability of a false positive may be made acceptably low.

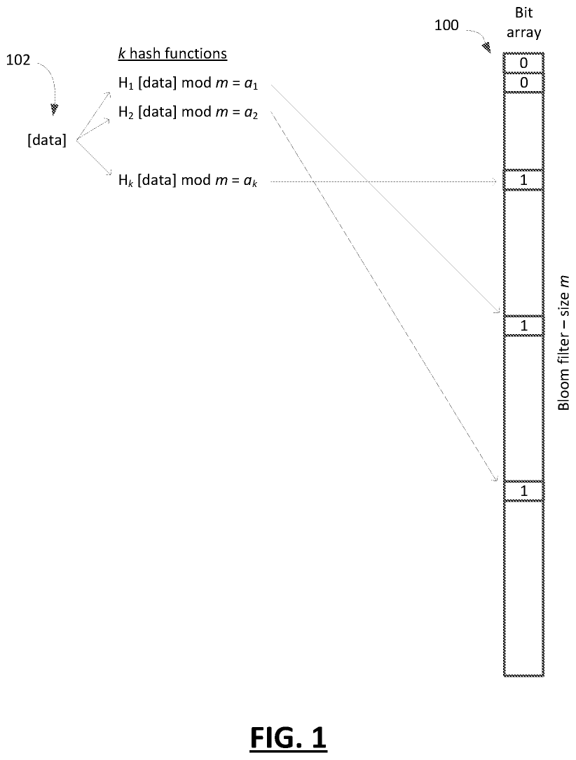

Reference is now made to FIG. 1, which illustrates an example bloom filter 100. The bloom filter 100 is a bit array of size m. Initially, all m bits in the array are set to zero. A data item 102 may be added to the bloom filter 100 by hashing the data item using k different hash functions, each of which maps the data element to one of the m array positions. As indicated in FIG. 1, each of the hash functions, Hn[data] mod m, results in a value an that points to one of the positions in the bloom filter 100 bit array. The binary value at each of those k positions is set to 1 to store the data item in the bloom filter 100.

Additional items may be added to the bit array by the same process of hashing the item using the k hash functions and setting the corresponding bits of the array to 1.

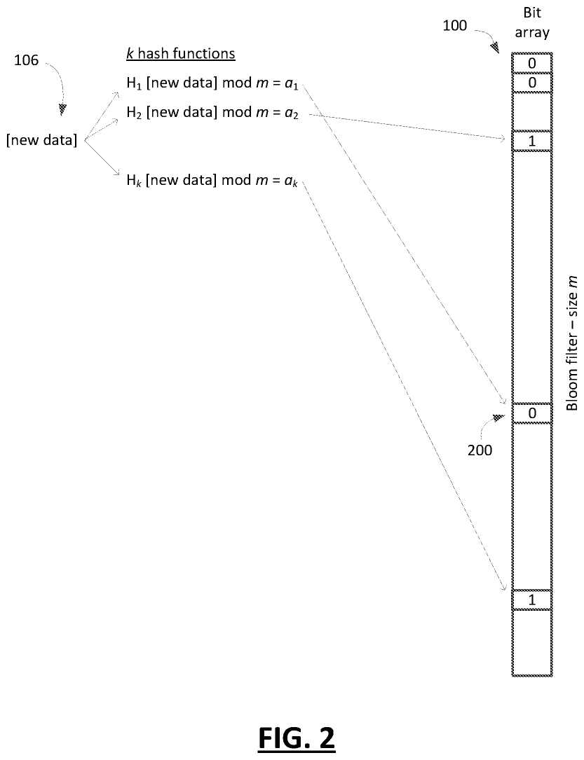

Reference is now also made to FIG. 2, which illustrates the example bloom filter 100. As indicated by FIG. 2, on receipt of a new data item 106, it may be determined whether the data item 106 is already in the bloom filter 100 by hashing it using the k hash functions to produce a set or series of k bit positions an, n=1 to k. If any of those k bit positions in the array contain a zero, as indicated by reference numeral 200, then the new data item 106 has not previously been added to the array. If all of the k bit positions contain a 1, then the new data item 106 was likely already added to the bloom filter 100, although there is a possibility that this is a false positive result.

If the k hash algorithms have an equal probability of mapping any input to any one of the m bit positions, then the probability that a particular bit in the array is not set to 1 by a certain hash function is given by:

$$1 - \frac{1}{m}$$

Accordingly, with k hash functions, then the probability that the bit is not set to 1 by any of the hash functions is given by:

$${( 1 - \frac{1}{m} )}^{k}$$

If the data being entered includes n items, then the probability of a bit not being set is:

$${( 1 - \frac{1}{m} )}^{k n}$$

and the probability that the bit is set to 1 by one of the data items is given by:

$$1 - {( 1 - \frac{1}{m} )}^{k n}$$

Therefore, when a new data item is received and an evaluation is being made as to whether it is in the bloom filter already, then the probability that all of the k array positions to which that data item is mapped being already set to 1 is given by:

$${( 1 - {( 1 - \frac{1}{m} )}^{k n} )}^{k}$$

This gives the likelihood of a false positive. Note that it depends on the number of hash functions, k, the size of the bit array, m, and the number of data items already in the bit array, n. When setting up a bloom filter, if the number of expected data items is known and a maximum likelihood of a false probability is selected, then it is possible to determine the number of hash functions:

$$k - \frac{m}{n} ln 2 ,$$

and the length of the bloom filter bit array:

$$m = - \frac{n ln p}{{( ln 2 )}^{2}}$$

A suitable false positive probability may be 0.005 in some examples. A false positive in the case of tracking partial POW reports may result in recording a “bad hash” against a mining device that did not actually produce a bad hash. If the penalty or other sanction is based on receiving two or three, or some larger number of bad hashes from one mining device, then the likelihood of a mining device being unfairly penalized may be made negligibly low.

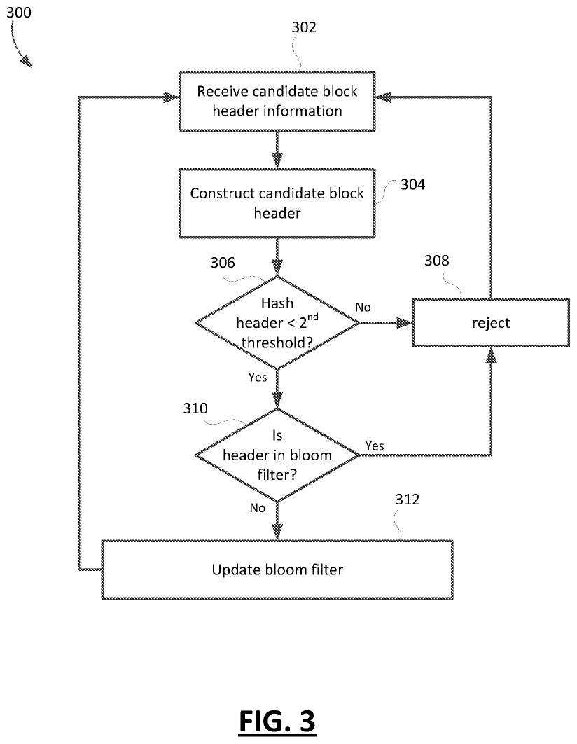

Reference is now made to FIG. 3, which illustrates, in flowchart form, one example method 300 of tracking proof-of-work contributions from mining devices within a mining pool. The method 300 may be implemented within a network-connected computing device, such as a pool master device in this example. The method 300 may be used to track bad hashes received from mining devices in a mining pool.

In operation 302, the pool master device receives candidate block header information. The candidate block header information is received from a mining device within the mining pool and may include, for example, a nonce value used by the mining device used in a candidate block header that, when hashed, met the partial POW standard, i.e. was below the higher threshold value set by the second difficulty parameter for that mining device. In some cases, the candidate block header information may further include additional data used by the mining device to construct the block header it hashed. In one example, the additional data may be Merkle tree root value. In another example, the additional data may be extranonce data from a field in a coinbase transaction.

In operation 304, the pool master device constructs the candidate block header based on the received candidate block header information. This may include inserting the nonce value from the candidate block header information into a partially-constructed block header. In some cases, it may include constructing the block of transactions and calculating the Merkle tree, which may include inserting the extranonce value into a coinbase transaction. The constructed candidate block header is the same block header that was hashed by the mining device based on the candidate block header information.

The pool master device then hashes the constructed candidate block header in operation 306 and assesses whether the result is below the higher threshold value set by the second difficulty parameter associated with the mining device from which the candidate header information was received. The hashing conforms to the applicable blockchain protocol's prescribed POW mechanism. In the case of some example blockchains, the hashing is a double-hash using SHA-256. If the hash result fails to fall below the higher threshold value, then in operation 308 the report is rejected. This may include recording a bad hash occurrence with respect to the mining device.

If the hash result falls below the higher threshold value, then the pool master device determines whether the candidate block header has already been added to the bloom filter in operation 310. As noted above, this may involve hashing the candidate block header with the k hash functions that map the candidate block header to k bit positions, and then assessing whether all of those bit positions in the bloom filter array have been set to 1. If they have, then the candidate block header has likely been added to the bloom filter previously and a bad hash may be recorded in operation 308. If at least one of the bit positions contains a zero value then the candidate block header has not been added before. Accordingly, in operation 312, the bloom filter is updated to add the candidate block header by setting all the k bit positions to 1. In some cases, operation 312 may further include incrementing a count of valid partial POW reports associated with the mining device.

It will be appreciated that the pool master device carries out the method 300 for each received partial POW report containing candidate block header information. If the mining pool succeeds in mining the current block, then the pool master device may determine the relative share of the block reward due to each mining device based on its contributed hashpower over the course of the mining activity for the current block. The contributed hashpower may be proportional to the second difficulty parameter used by that mining device in connection with its reported partial POW. Bad hashes recorded in association with a mining device may, in some cases, be used to adjust downwards that mining device's block reward share. In some cases, bad hashes may be used as the basis for excluding a mining device from a share of the block reward. In some cases, bad hashes may be used as the basis for expelling a mining device from the mining pool and preventing it from participating in further mining activity by the pool. In some cases, the relative share of block reward is further based on a count of valid partial POW reports from that mining device. For instance, the number of valid POW reports and the second difficulty parameter associated with each valid POW report from that mining device may be jointly used in determining a hashpower score or similar metric for that mining device, which may then be compared to the cumulative hashpower scores of all devices in the mining pool to determine block reward allocation amongst the mining devices.

If the mining pool does not succeed in mining the current block, but instead receives notification that another miner has succeeded in mining a block, then it may determine whether the bad hash count for any of the mining devices in the pool meets a threshold level for punitive action. Examples of punitive action include excluding the mining device from further participation in mining activity, reducing the mining device's allocation of future block rewards, or other such actions.

Once a valid block is found by the mining pool or by another mining pool, the bit array is zeroed and the method 300 begins anew with the search for the next block.

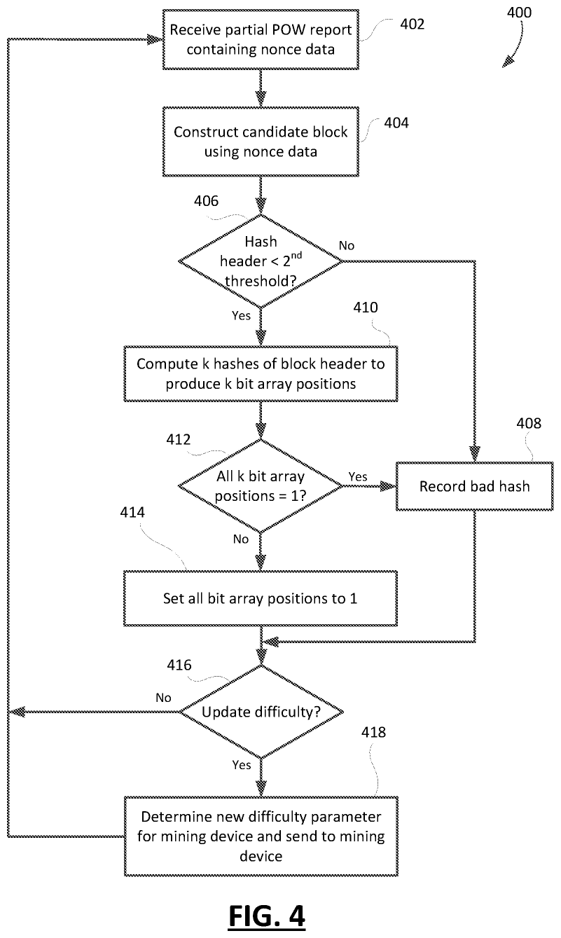

FIG. 4 shows, in flowchart form, another example method 400 of determining proof-of-work contributions from mining devices within a mining pool. The mining devices are tasked with mining a block containing a large quantity of transactions. As discussed above, a second difficultly parameter is set for each mining device. Each time the mining device finds a double-hashed block header that falls below the higher threshold value set by the second difficulty parameter, it transmits a partial POW report to the pool master device. As indicated by operation 402, the pool master device receives a report from a participating mining device containing nonce data corresponding to a block that meets the second difficultly parameter. The nonce data may include the nonce and the extranonce, if applicable. In operation 404, the pool master device constructs the candidate block using the nonce data provided by the participating mining device. It then carries out the applicable hashing operations which may include, for example, a double-hash of the block header using SHA-256. In operation 406, it assesses whether the hashed block header is less than the higher threshold value set by the second difficulty parameter for that participating mining device. If not, then it records a bad hash associated that participating mining device in operation 408.

If the reported candidate block header information results in a hashed header that is below the higher threshold value, then the pool master device carries out the k hash operations to find the k bit array positions, a₁, a₂, . . . , aₖ, to map the candidate block header to the bloom filter, as indicated by operation 410. In operation 412, the pool master device assesses whether those k bit array positions are already set to 1 in the bloom filter. If so, then it indicates, with some marginal possibility of error, that the candidate block header has already been recorded in the bloom filter, and the pool master device records a bad hash in operation 408. If any of the k positions in the bloom filter are 0, then the candidate block header has not been seen before and is valid. Accordingly, in operation 414 any of those k bit positions that are not already set to 1 are then set to 1 in the bloom filter to record the candidate block header.

In operation 416, the pool master device assesses whether to update the second difficulty parameter for the participating mining device. The decision may be based on a time between detection of valid candidate blocks that meet the second difficultly parameter. The time between detection of valid candidate blocks may be based on an average of two or more most-recent valid candidate blocks, or a weighted average time between most-recent valid candidate blocks in some cases. If the mining device is taking too long to find candidate blocks that meet the second difficulty parameter, then the parameter may be adjusted so as to increase the higher threshold value to make the search easier for that mining device. Conversely, if the mining device is finding valid candidate blocks too quickly, then the second difficultly parameter may be adjusted so as to lower the higher threshold value to make the search more difficult. Operation 418 indicates an adjustment to the second difficultly parameter is sent to the mining device. A history of adjustments or difficultly parameter may be maintained for each mining device so that a history of hashpower contributed over the time of mining a block is available for determining block reward allocation, in some embodiments. Once the second difficulty parameter has or has not been adjusted in operations 416 and 418, the method 400 returns to operation 402 to process the next partial POW report.

Once a valid new block has been found, whether by the mining pool or by another mining device outside the mining pool, then the bit array is cleared to set all positions to zero and the process beings anew with a new block being mined by the mining pool.

In one implementations, the k hash functions are implemented using one hash function that is used between 1 and k times. That is, the nth hash function is implemented by hashing the input data n times using same hash function. In one implementation, the hash function used may be the same hash function using in the blockchain protocol for determining whether the blockheader is below a threshold value, such as SHA-256 for example.

It will be appreciated that it may be that some or all of the above-described operations of the various above-described example methods may be performed in orders other than those illustrated and/or may be performed concurrently without varying the overall operation of those methods.

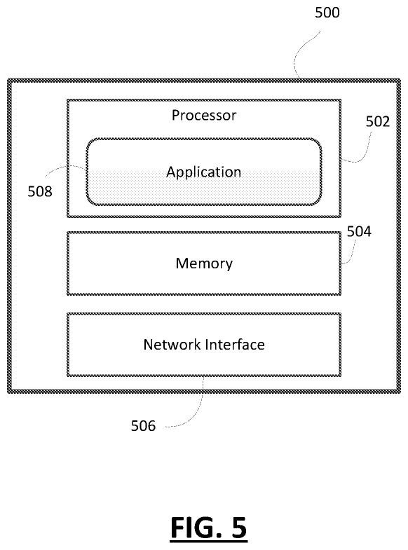

Reference is now made to FIG. 5, which shows, in block diagram form, a simplified computing device 500, in accordance with an example of the present application. The computing device 500 may carry out one or more of the above-described functions. In some examples, the computing device 500 may be a mining node within the mining pool that also carries out the pool master functions. In some implementations, the computing device 500 may be a non-mining node that operates to track and measure proof-of-work contributions of mining devices on behalf of a mining pool as a pool master device.

The computing device 500 includes a processor 502, which may include one or more microprocessors, application specific integrated circuits (ASICs), microcontrollers, or similar computer processing devices. The computing device 500 may further include memory 504, which may include persistent and non-persistent memory, to store values, variables, and in some instances processor-executable program instructions, and a network interface 506.

The computing device 500 may include a processor-executable application 508 containing processor-executable instructions that, when executed, cause the processor 502 to carry out one or more of the functions or operations described herein.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computer-implemented method of tracking proof-of-work contributions from mining devices within a mining pool, the mining pool having a pool master computing device that stores a bloom filter, the method comprising:
receiving candidate block header information from a first mining device within the pool;
constructing a candidate block header based on the candidate block header information;
determining that the candidate block header is not stored in the bloom filter; and,
based on the determination that the bloom filter does not contain the candidate block header, updating the bloom filter to store the candidate block header in the bloom filter.

2. The method claimed in claim 1, wherein the candidate block header information includes a nonce value and wherein constructing includes inserting the nonce value in the candidate block header.

3. The method claimed in claim 1, wherein the candidate block header information includes coinbase transaction data, and wherein constructing the candidate block header includes building a merkle tree based, in part, on the coinbase transaction data and populating a merkle root field of the candidate block header based on the merkle tree.

4. The method claimed in claim 1, wherein the bloom filter comprises a bit array, and wherein determining that the candidate block header is not stored in the bloom filter includes hashing the candidate block header using k hash functions to identify k bit positions, and determining that at least one of the k bit positions in the bit array is set to zero.

5. The method claimed in claim 4, wherein hashing using k hash functions includes repeatedly hashing the candidate block header k times using one hash function.

6. The method claimed in claim 4, wherein updating the bloom filter includes setting bits of the bit array in the k bit positions to 1.

7. The method claimed in claim 1, further comprising:
receiving second candidate block header information from a second mining device within the pool;
constructing a second candidate block header based on the second candidate block header information;
determining that the second candidate block header is likely stored in the bloom filter; and,
based on the determination that the bloom filter likely contains the second candidate block header, incrementing a count of invalid candidate blocks associated with the second mining device.

8. The method claimed in claim 7, wherein the bloom filter comprises a bit array, and wherein determining that the second candidate block header is likely stored in the bloom filter includes hashing the second candidate block header using k hash functions to identify k bit positions, and determining that all of the k bit positions in the bit array are set to one.

9. The method claimed in claim 1, further comprising hashing the candidate block header to produce a hash result, comparing the hash result to a higher threshold value set by a second difficulty parameter, and determining that the hash result is less than the higher threshold value.

10. The method claimed in claim 9, further comprising determining that a time of receipt between two or more partial proof-of-work reports containing candidate block header information from the first mining device deviates from a target duration by more than a threshold amount and, on that basis, adjusting the second difficulty parameter and sending the adjusted second difficulty parameter to the first mining device.

11. The method claimed in claim 1, further comprising determining that a valid block has been found by the mining pool and determining a share of a block reward allocated to the first mining device based on one or more of:
a second difficulty parameter associated with the first mining device,
a history of second difficulty parameters associated with the first mining device while mining the valid block, or
a count of partial proof-of-work reports received from the first mining device while mining the valid block.

12. The method claimed in claim 1, further comprising determining a count of bad hashes associated with each mining device in the mining pool and adjusting a relative share of block rewards allocated to each mining device based on the count of bad hashes associated with each respective mining device.

13. The method claimed in claim 12, wherein the count of bad hashes for a particular mining device is incremented by one when the particular mining device sends candidate block header information that either does not result in a hash value below a higher threshold value or is determined to already be stored in the bloom filter.

14. A pool master computing device to track proof-of-work contributions from mining devices within a mining pool, the computing device including:
one or more processors;
memory storing a bloom filter; and
computer-executable instructions stored in the memory that, when executed by the one or more processors, cause the processors to:
receive candidate block header information from a first mining device within the pool;
construct a candidate block header based on the candidate block header information;
determine that the candidate block header is not stored in the bloom filter; and
based on the determination that the bloom filter does not contain the candidate block header, update the bloom filter to store the candidate block header in the bloom filter.

15. A computer-readable medium storing processor-executable instructions for tracking proof-of-work contributions from mining devices within a mining pool, the mining pool having a pool master computing device that stores a bloom filter, the processor-executable instructions including instructions that, when executed by one or more processors, cause the processors to:
receive candidate block header information from a first mining device within the pool;
construct a candidate block header based on the candidate block header information;
determine that the candidate block header is not stored in the bloom filter; and
based on the determination that the bloom filter does not contain the candidate block header, update the bloom filter to store the candidate block header in the bloom filter.

16. The pool master computing device claimed in claim 14, wherein the candidate block header information includes a nonce value and wherein the instructions, when executed, are to cause the one or more processors to construct the candidate block header by inserting the nonce value in the candidate block header.

17. The pool master computing device claimed in claim 14, wherein the candidate block header information includes coinbase transaction data, and wherein the instructions, when executed, are to cause the one or more processors to construct the candidate block header includes building a merkle tree based, in part, on the coinbase transaction data and populating a merkle root field of the candidate block header based on the merkle tree.

18. The method of claim 12, wherein the bloom filter comprises a bit array, and the instructions, when executed, are to cause the one or more processors to determine that the candidate block header is not stored in the bloom filter by hashing the candidate block header using k hash functions to identify k bit positions, and determining that at least one of the k bit positions in the bit array is set to zero, wherein hashing using k hash functions includes repeatedly hashing the candidate block header k times using one hash function, and wherein updating the bloom filter includes setting bits of the bit array in the k bit positions to 1.

19. The method of claim 12, wherein the instructions, when executed, are to further cause the one or more processors to:
receive second candidate block header information from a second mining device within the pool;
construct a second candidate block header based on the second candidate block header information;
determine that the second candidate block header is likely stored in the bloom filter; and,
based on the determination that the bloom filter likely contains the second candidate block header, increment a count of invalid candidate blocks associated with the second mining device.

20. The method of claim 19, wherein the bloom filter comprises a bit array, and wherein the instructions, when executed, are to cause the one or more processors to determine that the second candidate block header is likely stored in the bloom filter by hashing the second candidate block header using k hash functions to identify k bit positions, and determining that all of the k bit positions in the bit array are set to one.

21. The pool master computing device claimed in claim 14, wherein the instructions, when executed, are to further cause the one or more processors to hash the candidate block header to produce a hash result, compare the hash result to a higher threshold value set by a second difficultly parameter, and determine that the hash result is less than the higher threshold value.

22. The pool master computing device claimed in claim 21, wherein the instructions, when executed, are to further cause the one or more processors to determine that a time of receipt between two or more partial proof-of-work reports containing candidate block header information from the first mining device deviates from a target duration by more than a threshold amount and, on that basis, adjust the second difficulty parameter to generate an adjusted second difficulty parameter and send the adjusted second difficulty parameter to the first mining device.

23. The pool master computing device claimed in claim 14, wherein the instructions, when executed, are to cause the one or more processors to determine that a valid block has been found by the mining pool and determine a share of a block reward allocated to the first mining device based on one or more of:
a second difficulty parameter associated with the first mining device,
a history of second difficulty parameters associated with the first mining device while mining the valid block, or
a count of partial proof-of-work reports received from the first mining device while mining the valid block.

24. The pool master computing device claimed in claim 14, wherein the instructions, when executed, are to further cause the one or more processors to: determine a count of bad hashes associated with each mining device in the mining pool and adjust a relative share of block rewards allocated to each mining device based on the count of bad hashes associated with each respective mining device, and wherein the count of bad hashes for a particular mining device is incremented by one when the particular mining device sends candidate block header information that either does not result in a hash value below a higher threshold value or is determined to already be stored in the bloom filter.
